(19) United States
(12) Patent Application Publication
(10) Pub. No.: US 2003/0125996 A1
(43) Pub. Date: Jul. 3, 2003

(54) System and method for managing capacity of professional and technical services

(75) Inventors: Erik Ramsten Bush, Alpharetta, GA (US); George Anthony Fioto JR., Raleigh, NC (US); John Arthur Ricketts, Willowbrook, IL (US)

Correspondence Address: Joseph T. Van Leeuwen, P.O. Box 81641, Austin, TX, 78708-1641, US

(73) Assignee: International Business Machines Corporation

(21) Appl. No.: 10/015,484

(22) Filed: Dec. 13, 2001

(51) Int. Cl. G06F 17/60

(52) U.S. Cl. 705/7

(57) ABSTRACT

A system and method for managing capacity of professional and technical services is presented. This invention creates a simulated environment and information system in which users make decisions corresponding to resource management. The user may input actual resource supply and actual resource demand, or the user may generate a resource supply and resource demand pattern based upon a pattern number. The user may enter a resource plan or may have a resource plan automatically generated. The simulation outputs a resource usage report file that allows the user to analyze a variety of capacity management situations.

### BACKGROUND OF THE INVENTION

1. Technical Field

The present invention relates in general to a system and method for managing capacity of professional and technical services. More particularly, the present invention relates to a system and method for simulating various resource supply and resource demand situations for training, research and decision-making purposes.

2. Description of the Related Art

Professional and technical services businesses face difficult capacity management issues. The lead-time to hire new resources is usually longer than customers will wait to start new projects, and inadequate capacity leads to lost business. Resources are deployed onto projects and return for redeployment, thereby coupling supply to demand and possibly leading to oscillation or persistent under- or over-capacity.

Aggregation of resource demand and supply across practices and geographies is difficult even though it has the potential to smooth overall capacity requirements. In the aggregate, normal contracts lead to relatively steady resource demand and resource supply, but large contracts may create large fluctuations in demand and supply. Demand comes from multiple sources, including new contracts, change authorizations, transfers to other organizations, or temporarily lending resources to other organizations.

Supply comes from multiple sources with different lead times and reliability, including resources returning from projects, new hires, sub-contractors, transfers from other organizations, and temporarily borrowing resources from other organizations.

Many supply and demand simulation programs are used in manufacturing and distribution environments. In manufacturing and distribution environments, supply is typically used once in producing a product. For example, a plastic housing for a widget is used in the production of the widget. It generally is not be used again to produce another widget. Plastic housing supply may be increased or decreased depending on the demand, independently of previous demand of plastic housings.

However, resources are routinely returned from engagements for redeployment in professional and technical services. This couples the current demand and previous supply (e.g., a decision to increase supply to meet current demand has a major impact on future supply). A challenge in professional and technical services business, and thereafter in the creation of a simulation of such businesses, is to design a capacity management method that recognizes this coupling.

Another challenge found with existing art is adjusting base and temporary capacity as needed rather than assuming a self-correcting situation. For example, in manufacturing and distribution environments, excess inventory is naturally depleted by demand, so special actions are not required. In professional and technical services, however, excess resources may not be depleted by demand, so care must be taken not to increase current capacity substantially beyond what future demand will require.

Resource managers are an integral part of capacity management. New resource managers may not have a vast amount of experience. They acquire proper resource management skills through real life situations. Experienced resource managers may not be exposed to most-effective capacity management methods. However, making mistakes with resource capacity management may cost a company a substantial amount of revenue and profit. For example, if a resource manager does not have enough resources to place on a project for a business, the project may become delinquent and the business may suffer as a result.

Another example is when a resource manager has too many resources for current projects, profit may be decreased because he or she is employing more people than he or she needs. A challenge found is effectively training resource managers on a variety of resource capacity situations without having the resource manager lose revenue or profit. Another challenge found is providing the resource manager with a scenario planning capability to determine optimum resource capacity for a given situation.

What is needed, therefore, is a way to train individuals on resource capacity management in a simulated environment and also use the simulated environment to perform actual resource management.

### SUMMARY

It has been discovered that resource managers may be effectively trained by providing a simulation environment that allows resource managers the ability to experience different business rules and decision strategies. The simulation encompasses a professional services environment and may also be used by resource managers for actual capacity planning.

This invention creates a simulated environment and information system in which users make decisions. A user selects a simulation mode which determines whether actual resource supply and resource demand information are used, or whether a generated pattern for resource supply and resource demand is used. The simulation mode also determines whether the simulation automatically provides resource planning inputs, or if the user provides resource planning inputs.

The simulation uses resource planning inputs, supply, demand, and other parameters to generate a resource output. This simulation allows users to compare traditional capacity management, which is driven by a long-term forecast, to an alternative approach to capacity management, which is driven by actual consumption and an optional short-term forecast.

By making resource decisions in a simulated environment, users gain experience with the dynamics of supply and demand in professional and technical services. Users also learn the effects on capacity of lead times for various sources of demand and supply, random and systematic variability in demand and supply, alternative business rules, such as “hire to actual consumption versus hire to forecast,” decision strategies, such as “maintain adequate capacity for all forecasted projects versus remain slightly supply constrained,” and available information, such as “long-term versus short-term forecasts with ‘what-if’ capability.”

The simulation allows users to change the conditions under which the simulation is executed under guidance of an instructor. Various demand patterns are selectable, including level demand, change to upswing, change to downswing, and cycles through up- and downswings. Various supply patterns are selectable, including low, moderate, and high variability. Various decision options are selectable, including or excluding imports/exports/transfers to other organizations.

The simulation allows researchers to adjust parameters. For example, researchers may change the equation for demand trend, parameters governing the wavelength and amplitude of business and seasonal cycles in demand, parameters governing the random component of demand, demand forecasting methods, forecast reliability, supply reliability, costs associated with various decisions, such as cost to hire, release, or transfer, revenue and costs associated with various outcomes, such as lost business or excess capacity.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a high-level flowchart showing three capacity management simulation modes;

FIG. 2 is a flowchart showing research mode processing;

FIG. 3 is a flowchart showing learning mode processing;

FIG. 4 is a flowchart showing decision-support mode processing;

FIG. 5 is a flowchart showing capacity management simulation;

FIG. 6 shows an input parameter window; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

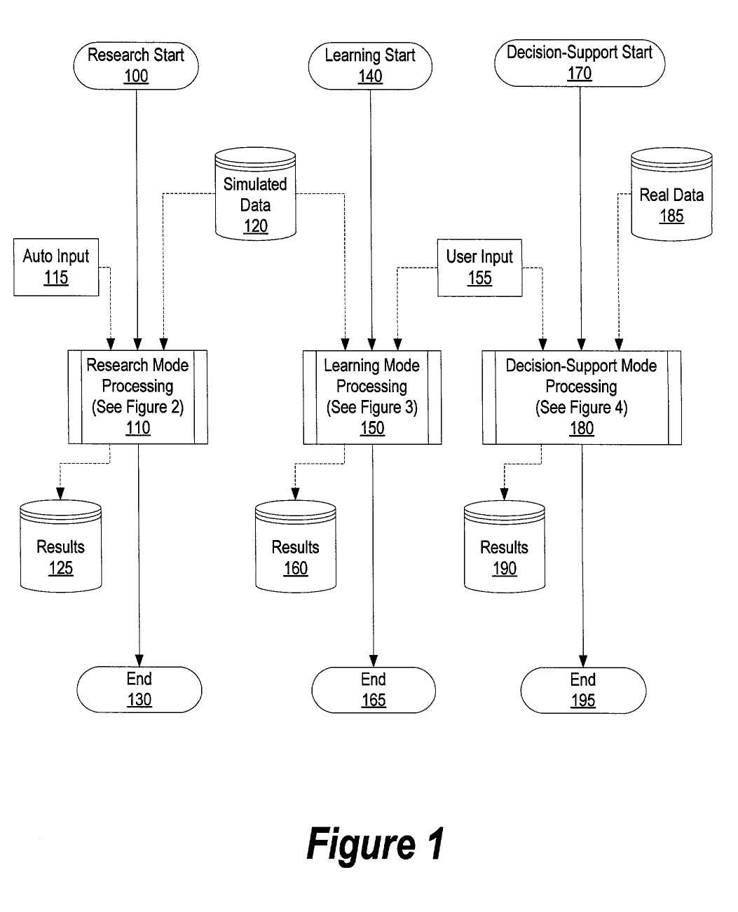

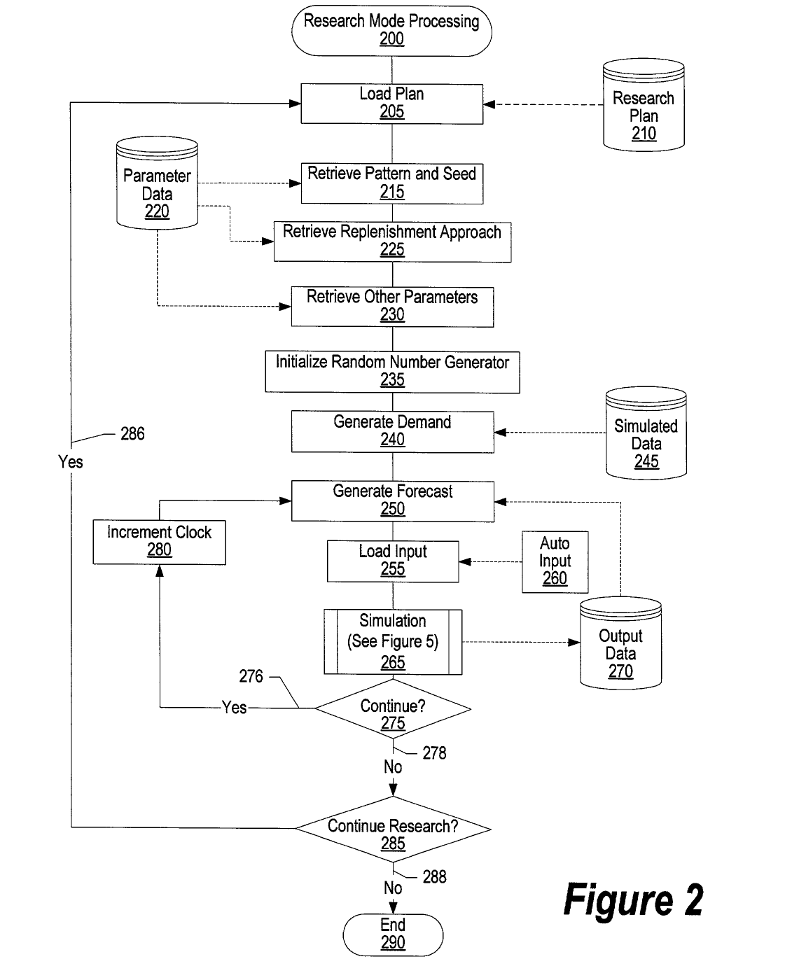

FIG. 1 is a high-level flowchart showing three capacity management simulation environments. The three simulation environments are research mode, learning mode, and decision-support mode. Research mode commences at 100, whereupon research mode processing is invoked (pre-defined process block 110, see FIG. 2 for further details). A researcher selects research mode to conduct research into capacity management.

Research mode simulates a capacity management environment and information system while simulating user decision-making behavior. The researcher may investigate the effects of various decision rules by defining rules used for decisions and by running the simulation in batch processing mode. For example, the researcher may investigate the effects of various decision rules and exogenous events, such as economic upturns and downturns, by rapidly executing hundreds of periods of simulated time under various conditions.

In research mode, researchers are able to change many parameters affecting the outcome of the simulation. For example, researchers may change the equation for demand trend, the parameters governing the wavelength and amplitude of business and seasonal cycles in demand, the parameters governing the random component of demand, the demand forecasting methods, the forecast reliability, the supply reliability, the costs associated with various decisions, such as cost to hire, release, or transfer, and the revenue and costs associated with various outcomes, such as lost business or excess capacity.

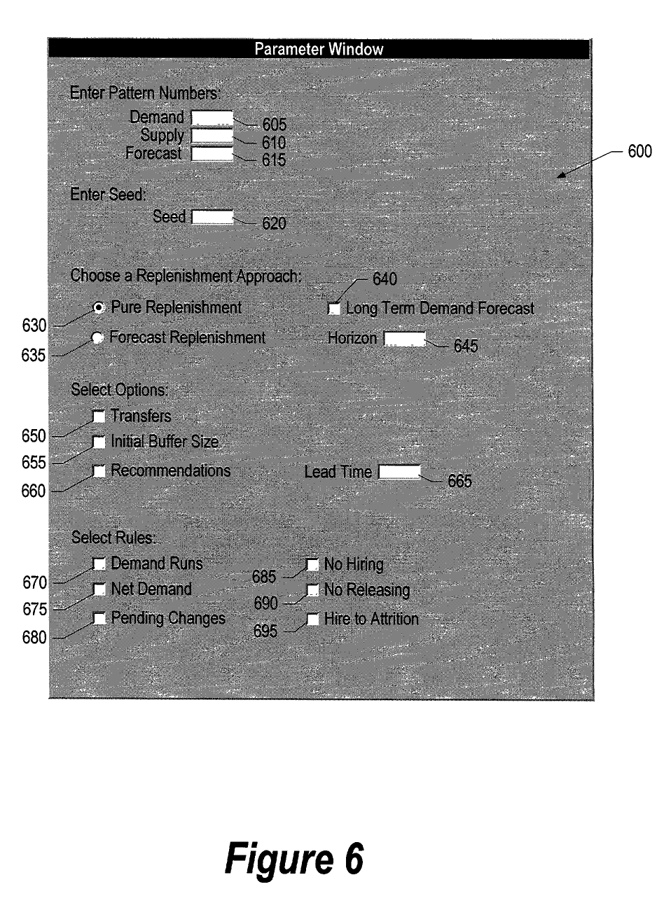

Research mode processing automatically receives resource plan input from auto input 115. Auto input 115 is a process which automatically provides various values, formulas, and rules to evaluate in simulation to determine the effectiveness of the values, formulas, and rules in managing capacity under both normal and extreme conditions. Research mode processing retrieves resource supply and resource demand input from simulated data 120. Simulated data 120 provides input corresponding to a pattern and seed number (see FIG. 6 for further details). Resource usage report results are stored in results 125, and research mode processing ends at 130.

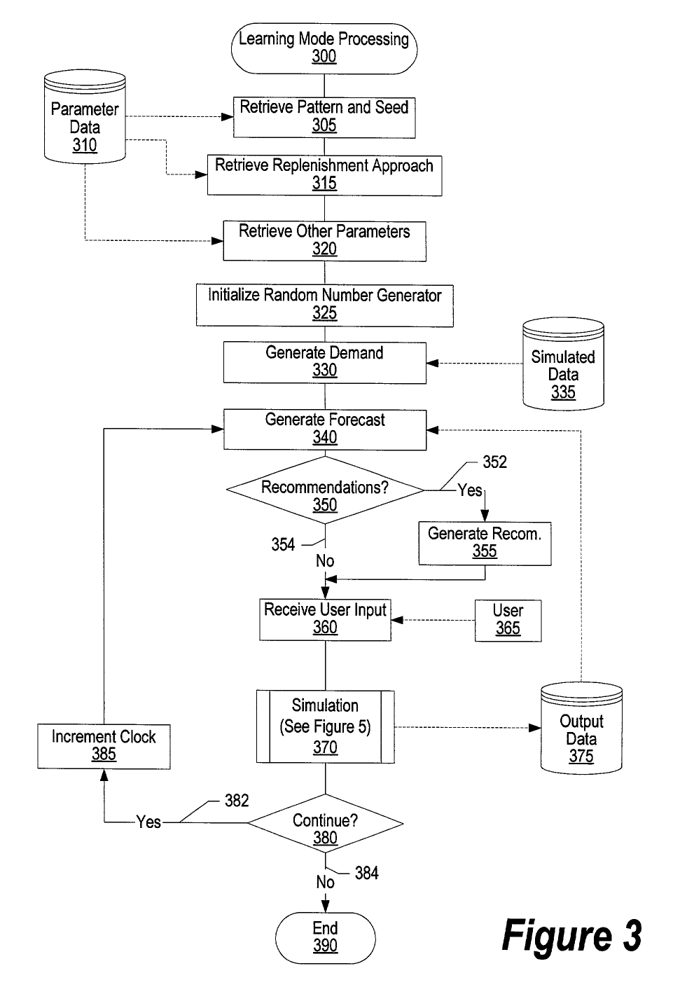

Learning mode commences at 140, whereupon learning mode processing is invoked (pre-defined process block 150, see FIG. 3 for further details). Learning mode allows users to learn capacity management for professional and technical services in a risk-free environment.

Learning mode creates a simulated environment and an information system in which users make decisions and discover consequences of those decisions. By repeating the simulation under various conditions, users gain knowledge of pitfalls to avoid and techniques for making better business decisions. Furthermore, discoveries made by researchers running the simulator in research mode are often shared with users running the simulator in learning mode to help them improve their decision-making.

Learning mode processing retrieves resource supply and resource demand input from simulated data 120. Simulated data 120 provides input corresponding to a pattern and seed number (see FIG. 6 for further details). Learning mode receives resource planning inputs from user input 155 for simulation. User input is from an actual user, unlike an automated input in research mode. Resource usage report results are stored in results 160, and learning mode processing ends at 165.

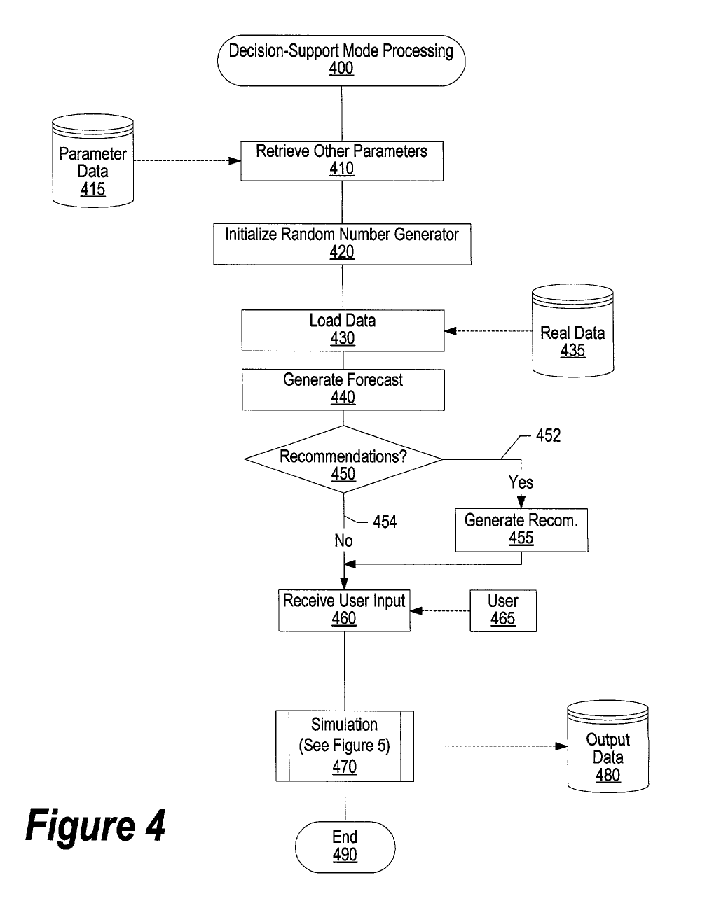

Decision-support mode commences at 170, whereupon decision-support mode processing is invoked (pre-defined process block 180, see FIG. 4 for further details). A user selects decision-support mode for actual capacity management of professional and technical services. Decision-support mode processing retrieves actual resource supply and actual resource demand from real data 185.

Decision-support mode receives resource planning inputs from user input 155 for simulation. User input is from an actual user, unlike an automated input in research mode. In decision-support mode, the simulation performs the calculations needed to maintain appropriate capacity based on actual or anticipated demand and supply conditions.

In addition, the simulation may be used to simulate future conditions and the outcome of proposed solutions in order to evaluate their effects and risks before real commitments are made. The results of decision-support mode processing are stored in results 190, and processing ends at 195.

FIG. 2 is a flowchart showing research mode processing. Processing commences at 200 whereupon a research plan is loaded from research plan store 210 (step 205). For example, the research plan may include various values, formulas, and rules to evaluate in simulation to determine the validity of the values, formulas, and rules. Research plan store 210 may be stored on a non-volatile storage area, such as a computer hard drive.

A pattern number and seed are retrieved from parameter data store 220 at step 215. Each pattern number is associated with a collection of values and formulas corresponding to demand, supply, and forecast information that generate a simulated environment and information system. The seed number allows multiple users to experience the same simulated conditions, if desired. It also establishes repeatability for demonstration and statistical purposes.

A replenishment approach is received from parameter data store 220 at step 225. The replenishment approach increases or decreases the number of resources in a given skill group whenever the current number of resources is not consistent with a current or anticipated market demand. The user may select a pure replenishment approach or a forecast replenishment approach. The pure replenishment approach manages capacity to actual demand. The forecast replenishment approach manages capacity to a short-term, operational forecast.

Other parameters are retrieved from parameter data store 220 at step 230. Other parameters may include a set of predefined rules. Predefined rules may include demand runs, net demand, pending changes, no hiring, no releasing, or hire to attrition (see FIG. 6 for further details).

Arrays and a random number generator are initialized at 235. The random number generator is used to generate realistic values for demand and supply that contain some amount of random error. A resource demand is generated at step 240. Resource demand is generated using the following formula:

Demand=Trend+Season+Bus. Cycle+Error

Trend is long-term direction for demand (usually linear with positive or negative slope). Season is systematic variability around the trend corresponding to annual or semi-annual cycles (e.g. peak seasons occur in spring and fall, slack seasons occur in summer and winter). Business cycle is systematic variability around the trend corresponding to multi-year cycles. Error is random variability drawn from a statistical distribution according to parameters and one or more random numbers (e.g. the parameters for randomly distributed error are the mean and standard deviation of the normal distribution).

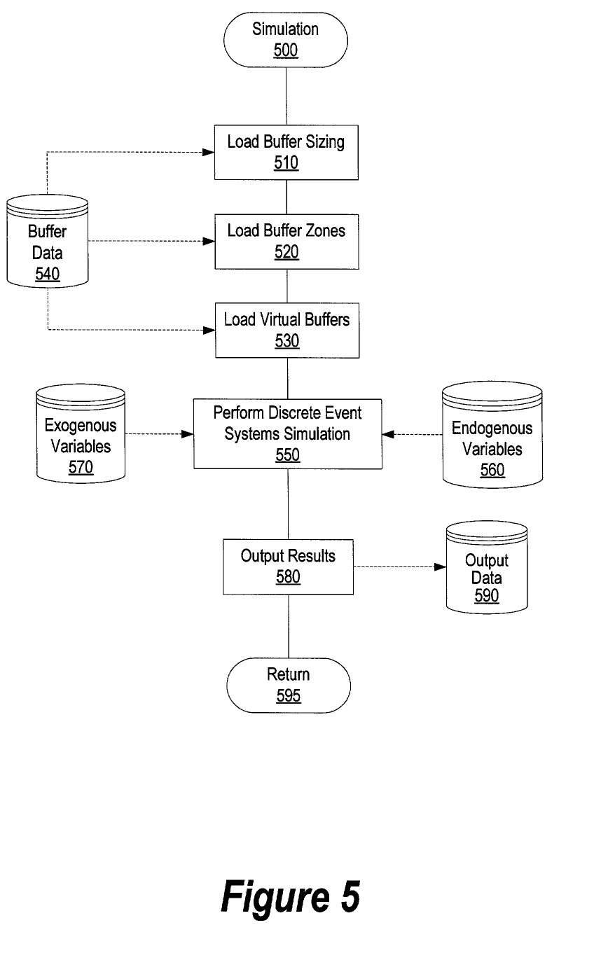

A forecast is generated at step 250. Resource plan inputs are automatically entered from auto input 260 at step 255. Resource plan inputs may include increasing resources via hiring, transferring resources in, or obtaining subcontractors. Other input decision may be decreasing resources by releasing employees, transferring employees out, returning subcontractors, or letting resources decrease through attrition. Processing performs a simulation using the rules, inputs, resource supply, and resource demand to generate a resource usage report (pre-defined process block 265, see FIG. 5 for further details). The resource usage report results are stored in output data store 270.

A determination is made as to whether processing continues to simulate the subsequent time period (e.g. week, etc.) using the same research plan and pattern number (decision 275). If processing continues using the same research plan and pattern number, decision 275 branches to “Yes” branch 276 which loops back to increment the clock to the next time period (step 280) and process the subsequent time period. This looping continues until processing stops using the same research plan and pattern number for simulation, at which point decision 275 branches to “No” branch 278.

A determination is made as to whether to continue research using a different research plan, pattern number, or seed number (decision 285). If research continues using a different research plan, pattern number, or seed number, decision 285 branches to “yes” branch 286 which loops back to process another research simulation starting at the initial time period. This looping continues until research ends, at which point decision 285 branches to “No” branch 288 and processing ends at 290.

FIG. 3 is a flowchart showing learning mode processing. Processing commences at 300 whereupon a pattern number and seed are retrieved from parameter data store 310 at step 305. Each pattern number is associated with a collection of values and formulas corresponding to demand, supply, and forecast that generate a simulated environment and information system. The seed number allows multiple users to experience the same simulated conditions.

A replenishment approach is received from parameter data store 310 at step 315. The replenishment approach increases or decreases the number of resources in a given skill group whenever the current number of resources is not consistent with a current or anticipated market demand. A user may select a pure replenishment approach or a forecast replenishment approach. The pure replenishment approach manages capacity to actual demand. The forecast replenishment approach manages capacity to a short-term, operational forecast.

Other parameters are retrieved at step 320 from parameter data store 310. Other parameters may include a set of predefined rules. Predefined rules may include demand runs, net demand, pending changes, no hiring, no releasing, or hire to attrition (see FIG. 6 for further details).

Arrays and a random number generator are initialized at 325. The random number generator is used to generate realistic values for demand and supply that contain some amount of random error. A resource demand is generated at step 330 by using resource supply, resource demand, and forecast information located in simulated data store 335.

A forecast is generated at step 340. A determination is made as to whether a user wants recommendations generated to assist him in entering resource inputs (decision 350, see FIG. 6 for further details). If the user chooses to have recommendations generated, decision 350 branches to “Yes” branch 352 whereupon recommendations are generated (step 355). On the other hand, if the user does not want to have recommendations generated, decision 350 branches to “No” branch 354, bypassing recommendation generation.

Resource plan input is received from user 365 (step 360). Resource plan input may include increasing resources by hiring, transferring resources in, or obtaining subcontractors. Other input decision may be decreasing resources by releasing employees, transferring employees out, returning subcontractors, or letting resources decrease through attrition.

Processing performs a simulation using the rules, inputs, resource supply, and resource demand (pre-defined process block 370, see FIG. 5 for further details). The resource usage report results are stored in output data store 375.

A determination is made as to whether processing continues to simulate the subsequent time period (e.g. week, etc.) (decision 380). If processing continues, decision 380 branches to “Yes” branch 382 which loops back to increment the clock to the next time period (step 385) and process the subsequent time period. This looping continues until processing terminates, at which point decision 380 branches to “No” branch 384 and processing ends at 390.

FIG. 4 is a flowchart showing decision-support mode processing. Processing commences at 400, whereupon other parameters are retrieved from parameter data store 415 at step 410. Other parameters may include a set of predefined rules. Predefined rules may include demand runs, net demand, pending changes, no hiring, no releasing, or hire to attrition (see FIG. 6 for further details).

Arrays and a random number generator are initialized at 420. The random generator is used to generate realistic lag times between when a decision is made and when its effects are felt. Actual resource supply and actual resource demand information are loaded from real data store 435 (step 430). Actual resource supply and actual demand may be from an ongoing resource management situation. Real data 435 may be a non-volatile storage area, such as a computer hard drive.

A forecast is generated at step 440. A determination is made as to whether a user wants recommendations generated to assist him in entering resource plan inputs (decision 450). If the user wants to have recommendations generated, decision 450 branches to “Yes” branch 452 whereupon recommendations are generated (step 455). On the other hand, if the user does not want recommendations generated, decision 450 branches to “No” branch 454, bypassing recommendation generation.

Resource input is received from user 465 (step 460). Resource plan inputs may include increasing resources via hiring, transferring resources in, or obtaining subcontractors. Other input decision may be decreasing resources by releasing employees, transferring employees out, returning subcontractors, or letting resources decrease through attrition.

Processing performs a simulation using the rules, inputs, resource supply, and resource demand (pre-defined process block 470, see FIG. 5 for further details). The resource usage report results are stored in output data store 480 and processing ends at 490. In decision-support mode, the user may run the simulation once each time period (e.g. week, etc.) using actual data as of that time period.

FIG. 5 is a flowchart showing capacity management simulation. Processing commences at 500, whereupon a buffer size is loaded from buffer data 540 at step 510. The buffer size is usually based on the variability of net consumption (i.e. demand minus supply) and may be specified in standard deviations of net consumption. For example, if net consumption is normally distributed and the buffer size needs to cover 99% of the variability, the standard deviation to use is three.

Higher variability generates a larger buffer since the purpose of the buffer is to protect revenue and net profit from variability. Special cases may be required, however, when net consumption is persistently negative (supply exceeds demand), persistently positive (demand exceeds supply), or the variability is virtually zero (demand and supply are in equilibrium). In these cases the buffer size is based on total net consumption during the time to re-supply.

Buffer zones are loaded from buffer data 540 at step 520. Buffer zones may be asymmetric or symmetric and the width of each buffer zone may be calibrated so that net consumption is expected to fall within that zone with a given probability. Buffer zones may be divided into three zones which are excess, normal, and shortage. When actual capacity falls in the “excess zone”, a reduction in capacity may be needed. When actual capacity falls in the “normal zone”, no adjustment is required. When actual capacity falls in the “shortage zone”, an increase in capacity is needed.

For example, if the buffer size is +/−3 standard deviations of net consumption, the threshold between the “excess” and “normal” zones may be set to +2 standard deviations. Likewise, the threshold between the “shortage” and “normal” zone may be set at −2 standard deviations. Thus, capacity adjustments are triggered more often if the buffer size is small or the “normal” zone is narrow.

Virtual buffers are loaded from buffer data 540 at step 530. Virtual buffers may be used to view resource availability across skill groups when resources have both one primary skill code that defines a skill group and other secondary skill codes. A virtual buffer is comprised of excess resources in one skill group with a secondary skill code that matches the primary skill code for a skill group experiencing a shortage of resources. Virtual buffers may be managed according to the same rules as actual buffers.

Discrete event systems simulation is performed at step 550 using exogenous variables 570 and endogenous variables 560 to generate a resource usage report. As will be appreciated by those skilled in the art, discrete event systems analysis models the behavior of a system over time but the state of the simulated system changes only at discrete points in simulated time.

Exogenous variables include market demand, supply from the labor market, supply from subcontractors, attrition, timing of resource returns, willingness of other players to transfer resources in or accept transfers out.

Endogenous variables include decisions to increase or decrease capacity, and the source of supply. Discrete event systems simulation uses pseudo-random numbers drawn from the uniform, normal, discrete, triangular, beta, and rayleigh distributions to simulate variability in demand and supply. Supply is calculated using the following formula:

SUPPLY=SPP+NH−ATR−IS+RTN−DEP+IMP−EXP+TFI−TFO+SUBIN−SUBOUT

where SPP is supply from previous period; NH is new hires; ATR is attrition; IS is involuntary separations; RTN is returns; DEP is deployment; IMP is imports; EXP is exports; TFI is transfers in; TFO is transfers out; SUBIN is subcontractors in; SUBOUT is subcontractors out.

Resource usage report results are sent to output data store 590 at step 580. Resource usage report results may be resource quantity information, forecast information, financial information, and various charts. Resource quantity information may include information about the number of available resources or shortage of resources. Forecast information may include information about the potential resource surplus or shortages in the future. Financial information may include revenue from resources and cost of the resources. Various charts may include a resource supply versus a resource demand chart, a financial performance chart, or a total resources chart. Capacity management simulation processing returns at 595.

FIG. 6 shows an input parameter window. Parameter window 600 includes various parameters that affect the simulation outcome. The user may change the demand pattern by entering a different number in text box 605. The user may change the supply pattern by entering a number in text box 610. The user enters a number in text box 615 to change the forecast pattern. Each pattern number for demand, supply, and forecast is associated with a collection of values and formulas that generate the simulated environment and information system.

A user may enter a seed number in text box 620. Ordinarily, each time the simulation is run, demand and supply are different even if the same pattern numbers are selected. If, however, a user wants to have the same simulation environment as another user, both users may enter the same integer in text box 620 along with the same pattern numbers for supply, demand, and forecast.

The user may select a replenishment approach by selecting radio button 630 or radio button 635. The replenishment approach increases or decreases the number of resources in a given skill group whenever the current number of resources is not consistent with current or anticipated market demand. The user may select a pure replenishment approach (radio button 630) which manages capacity to actual demand. The user may instead select forecast replenishment approach (radio button 635) which manages capacity to a short-term, operational forecast.

If the user selects the pure replenishment approach, he or she may also select a long-term demand forecast (check box 640). If the user selects forecast replenishment approach, he or she may enter a forecast horizon in text box 645 corresponding to the number of weeks to cover by the short-term, operational forecast.

The user may select various simulation options. The user may select transfers (check box 650) to enable transfers between his or her skill group and another skill group. Negotiation of transfers may be performed directly between users, moderated by a third party, or through simulation.

A user may select initial buffer sizing (check box 655) if he or she wants an initial resource buffer size automatically computed. The resource buffer size is based on variability of net consumption.

A user selects recommendations (check box 660) if he or she wants the simulation to compute the number of resources to hire or release each period based on current capacity, the buffer zones, and active rules. Users may override the recommendations before committing to resource decisions.

If the user selects forecast replenishment (radio button 635) and recommendations (check box 660), he or she may enter a lead-time for the recommendations (text box 665). If text box 665 is blank, recommendations are based on the period in the forecast horizon furthest in the future.

The user may select demand rules to assist him or her in resource planning. The user may select demand run check box 670. The demand run rule represents that resource hiring is triggered when the demand rises in more forecast periods than it falls in forecast periods, and visa versa for resource releasing.

The user may select net demand check box 675. The net demand run rule represents that resource hiring is triggered when the net change in demand during forecast periods is greater than zero, or less than zero to trigger resource releasing.

The user may select pending changes check box 680. The pending changes rule indicates that pending resource hires prevent resource release recommendations, and pending resource releases prevent resource hiring recommendations.

The user may select no hiring check box 685. The no hiring rule signifies that no resource hiring recommendations are generated. The user may select no releasing check box 690. The no releasing rule signifies that no resource releasing rules are generated. The user may select hire to attrition check box 695. The hire to attrition rule connotes that resource hiring recommendations match resource attrition unless another rule inhibits hiring.

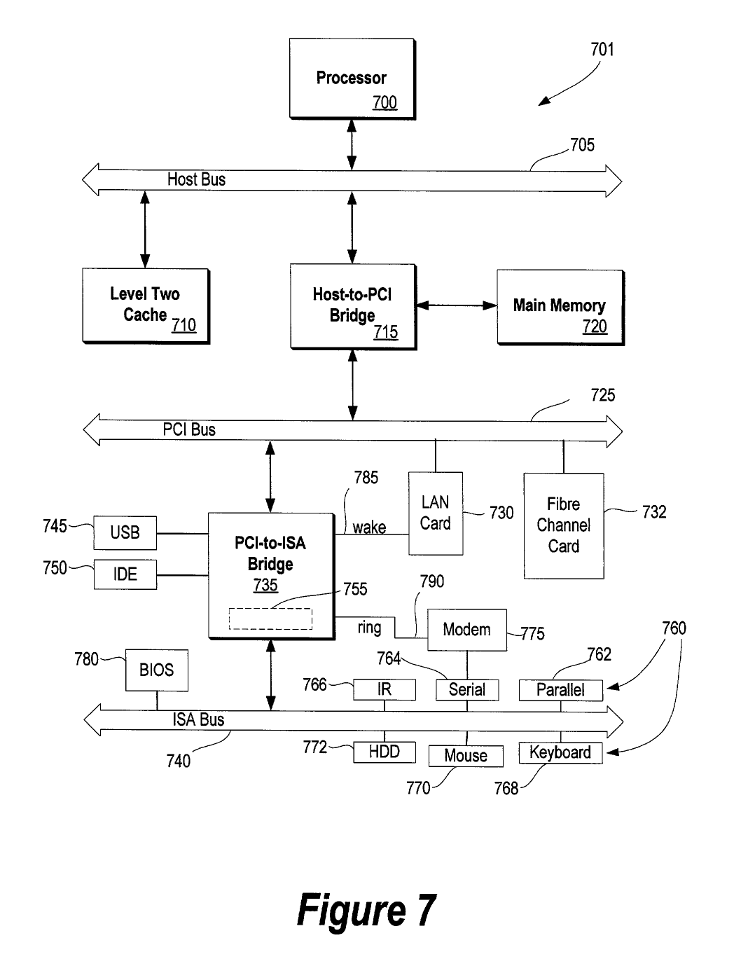

FIG. 7 illustrates information handling system 701 which is a simplified example of a computer system capable of performing the server and client operations described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (i.e., parallel interface 762, serial interface 764, infrared (IR) interface 766, keyboard interface 768, mouse interface 770, and fixed disk (HDD) 772) coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 to another computer system to copy files over a network, LAN card 730 is coupled to PCI bus 725 and to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of managing resources, said method comprising:
receiving one or more buffer variables and one or more endogenous variables;
determining one or more exogenous variables; and
simulating one or more resource requirements using the buffer variables, the endogenous variables, and the exogenous variables.

2. The method as described in claim 1 wherein the buffer variable is selected from the group consisting of a buffer size, a buffer zone, and a virtual buffer.

3. The method as described in claim 1 further comprising:
selecting a simulation mode; and
receiving a resource plan input based on the selected simulation mode.

4. The method as described in claim 3 wherein the simulation mode is selected from the group consisting of a research mode, a learning mode, and a decision-support mode.

5. The method as described in claim 1 wherein at least one of the endogenous variables is selected from the group consisting of a capacity increase decision, a capacity decrease decision, and a resource supply source.

6. The method as described in claim 1 wherein at least one of the exogenous variables is determined by calculating a resource supply.

7. The method as described in claim 1 further comprising:
generating a resource usage report that includes the resource requirements in response to the simulation.

8. The method as described in claim 1 wherein the simulating includes performing discrete event systems simulation.

9. The method as described in claim 1 further comprising:
selecting a replenishment mode, the replenishment mode including a pure replenishment mode and a forecast replenishment mode; and
including the selected replenishment mode as an input to the simulating.

10. An information handling system comprising:
one or more processors;
a memory accessible by the processors;
one or more nonvolatile storage devices accessible by the processors;
a resource management tool, the resource management tool including:
means for receiving one or more buffer variables and one or more endogenous variables;
means for determining one or more exogenous variables; and
means for simulating one or more resource requirements using the buffer variables, the endogenous variables, and the exogenous variables.

11. The information handling system as described in claim 10 wherein the buffer variable is selected from the group consisting of a buffer size, a buffer zone, and a virtual buffer.

12. The information handling system as described in claim 10 further comprising:
means for selecting a simulation mode; and
means for receiving a resource plan input based on the selected simulation mode.

13. The information handling system as described in claim 12 wherein the simulation mode is selected from the group consisting of a research mode, a learning mode, and a decision-support mode.

14. The information handling system as described in claim 10 wherein at least one of the endogenous variables is selected from the group consisting of a capacity increase decision, a capacity decrease decision, and a resource supply source.

15. The information handling system as described in claim 10 wherein at least one of the exogenous variables is determined by calculating a resource supply.

16. The information handling system as described in claim 10 further comprising:
means for generating a resource usage report that includes the resource requirements in response to the simulation.

17. The information handling system as described in claim 10 wherein the simulating includes performing discrete event systems simulation.

18. The information handling system as described in claim 10 further comprising:
means for selecting a replenishment mode, the replenishment mode including a pure replenishment mode and a forecast replenishment mode; and
means for including the selected replenishment mode as an input to the simulating.

19. A computer program product stored in a computer operable media for managing resources, said computer program product comprising:
means for receiving one or more buffer variables and one or more endogenous variables;
means for determining one or more exogenous variables; and
means for simulating one or more resource requirements using the buffer variables, the endogenous variables, and the exogenous variables.

20. The information handling system as described in claim 19 wherein the buffer variable is selected from the group consisting of a buffer size, a buffer zone, and a virtual buffer.

21. The information handling system as described in claim 19 further comprising:
means for selecting a simulation mode; and
means for receiving a resource plan input based on the selected simulation mode.

22. The information handling system as described in claim 21 wherein the simulation mode is selected from the group consisting of a research mode, a learning mode, and a decision-support mode.

23. The information handling system as described in claim 19 wherein at least one of the endogenous variables is selected from the group consisting of a capacity increase decision, a capacity decrease decision, and a resource supply source.

24. The information handling system as described in claim 19 wherein at least one of the exogenous variables is determined by calculating a resource supply.

25. The information handling system as described in claim 19 further comprising:
means for generating a resource usage report that includes the resource requirements in response to the simulation.

26. The information handling system as described in claim 19 wherein the simulating includes performing discrete event systems simulation.

27. The information handling system as described in claim 19 further comprising:
means for selecting a replenishment mode, the replenishment mode including a pure replenishment mode and a forecast replenishment mode; and
means for including the selected replenishment mode as an input to the simulating.
